(19) United States
(12) Patent Application Publication
(10) Pub. No.: US 2015/0233547 A1
(43) Pub. Date: Aug. 20, 2015

(54) DECORATIVE LIGHT

(71) Applicant: Clear Innovation LLC, New York, NY (US)

(72) Inventor: Maurice S. Dayan, Oakhurst, NJ (US)

(21) Appl. No.: 14/623,931

(22) Filed: Feb. 17, 2015

Related U.S. Application Data
(60) Provisional application No. 61/940,723, filed on Feb. 17, 2014.

(51) Int. Cl. F21V 13/08; F21V 23/02; F21V 23/04; F21V 31/00

(52) U.S. Cl. CPC F21V 13/08; F21V 31/005; F21V 23/023; F21V 23/04; F21W 2131/401

(57) ABSTRACT

A decorative light includes a housing having a bottom shell and a top shell, with the shells configured to seal against each other along an outer perimeter. A partial mirror is affixed to an inside of the top shell, and an internal support plate includes a mirrored surface facing the partial minor. A plurality of lighting elements are disposed between the partial mirror and the mirrored surface, and a plurality of light filters are disposed about a periphery of the mirrored surface, each light filter being disposed between two of the lighting elements.

### CROSS REFERENCE TO RELATED APPLICATIONS

Priority is claimed U.S. provisional patent application Ser. No. 61/940,723, filed Feb. 17, 2014, the disclosure of which is incorporated herein by reference in its entirety.

### FIELD OF THE INVENTION

The field of the present invention relates to decorative lights to provide decorative illumination, and particularly lights which are used in or on a body of water.

### BACKGROUND OF THE INVENTION

Bodies of water are frequently included as part of landscape and architectural designs. At times it is desirable to decorate the bodies of water in order to highlight them as part of the landscape or architectural features, or simply to introduce an additional festive appearance. Frequently, such bodies of water are decorated with fountains and lights. In most instances, the lights are positioned and arrange to illuminate the water and or surfaces underneath the water. It is desirable to have other types of decorative lights for such bodies of water to provide illumination features that are not presently available in the market.

### SUMMARY OF THE INVENTION

The present invention is directed toward a decorative light which provides decorative illumination. The decorative light includes a housing having a bottom shell and a top shell, with the shells configured to seal against each other along an outer perimeter. A partial mirror is affixed to an inside of the top shell, and an internal support plate is disposed within the housing and includes a mirrored surface facing the partial minor. A plurality of lighting elements are disposed between the partial mirror and the mirrored surface, and a plurality of light filters are disposed about a periphery of the mirrored surface, with each light filter being disposed between two of the lighting elements.

Accordingly, an improved decorative light is disclosed. Advantages of the improvements will be apparent from the drawings and the description of the preferred embodiment.

### BRIEF DESCRIPTION OF THE DRAWINGS

The foregoing summary, as well as the following detailed description of the exemplary embodiments, will be better understood when read in conjunction with the appended drawings. It should be understood, however, that the invention is not limited to the precise arrangements and instrumentalities shown in the following figures:

FIG. 1 illustrates a perspective view of a decorative light;

FIG. 2 illustrates an exploded view of the decorative light of FIG. 1;

FIG. 3 illustrates a sectional view of the decorative light along the line III-III of FIG. 1;

FIG. 4 illustrates a perspective view of the top shell of the decorative light of FIG. 1;

FIG. 5 illustrates a bottom elevation view of the top shell of FIG. 4;

FIG. 6 illustrates a top elevation view of the internal support plate affixed to the bottom shell of the decorative light of FIG. 1; and

FIG. 7 illustrates decorative illumination from the decorative light of FIG. 1, shown without the top shell for clarity.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combinations of features that may exist alone or in other combinations of features; the scope of the invention being defined by the claims appended hereto.

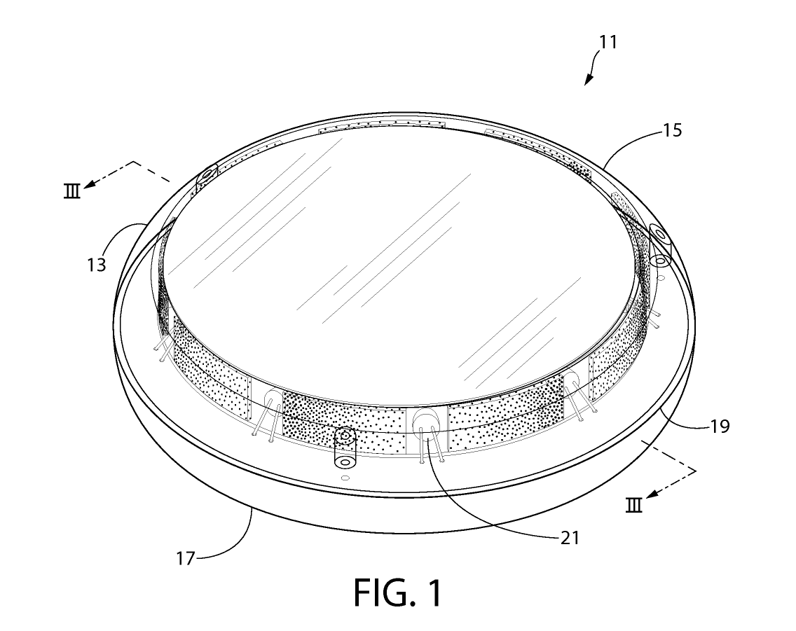

Turning in detail to the drawings, the decorative light 11 shown in FIG. 1 is configured to be buoyant in water and provide decorative illumination directed laterally along the surface of the water and up and away from the surface of the water. The decorative light may be configured to be buoyant in other liquids by appropriate configuration of the volume of the decorative light to its mass, although for purposes of the ensuing description, the disclosed embodiments of the decorative light are intended for use in water.

The decorative light 11 has a housing 13 which includes a top shell 15 and a bottom shell 17. The top shell 15 and the bottom shell 17 mate together to form a seal 19 about an outer perimeter of the housing 13, thereby protecting the interior of the housing 13 against ingress of water, so that the housing 13 forms a buoyant body. The seal 19 may be a substantially water tight barrier (i.e., water will not typically pass the seal so long as the seal is not submerged in water), as the decorative light 11 is intended to float on the surface of water, with the seal positioned so as to be disposed above the water line on the housing when the decorative light is floating. In embodiments in which the seal rests below the waterline, it may be desirable to make the seal a water-proof barrier (i.e., water will not pass through the seal when the seal is submerged in water, up to a predetermined depth) to better protect the interior of the housing 13 against the ingress of water.

Inside the housing 13, the decorative light includes a plurality of lighting elements, shown as LEDs 21 in the figures, and the LEDs are controlled by driver circuit (not shown). Other types of lighting elements may be used. The LEDs 21 illuminate in the visible spectrum, and they may be single color LEDs or multi-color LEDs. Each LED may be of any type or color, independently of the other LEDs. For example, of the nine LEDs 21 shown, three may be one color, three may be a second color, and three may be a third color, with all three colors being different. Alternatively, each of the LEDs 21 may be a tri-color LED. In all embodiments, the selection of which LED is illuminated during operation, and how they are illuminated (e.g., steady state illumination, flashing illumination at predetermined intervals, or in the case of multi-color LEDs, which color is illuminated), is controlled by the driver circuit.

As shown, the LEDs 21 are distributed in a circular pattern, evenly spaced apart. Other distribution and spacing patterns may be used in other embodiments.

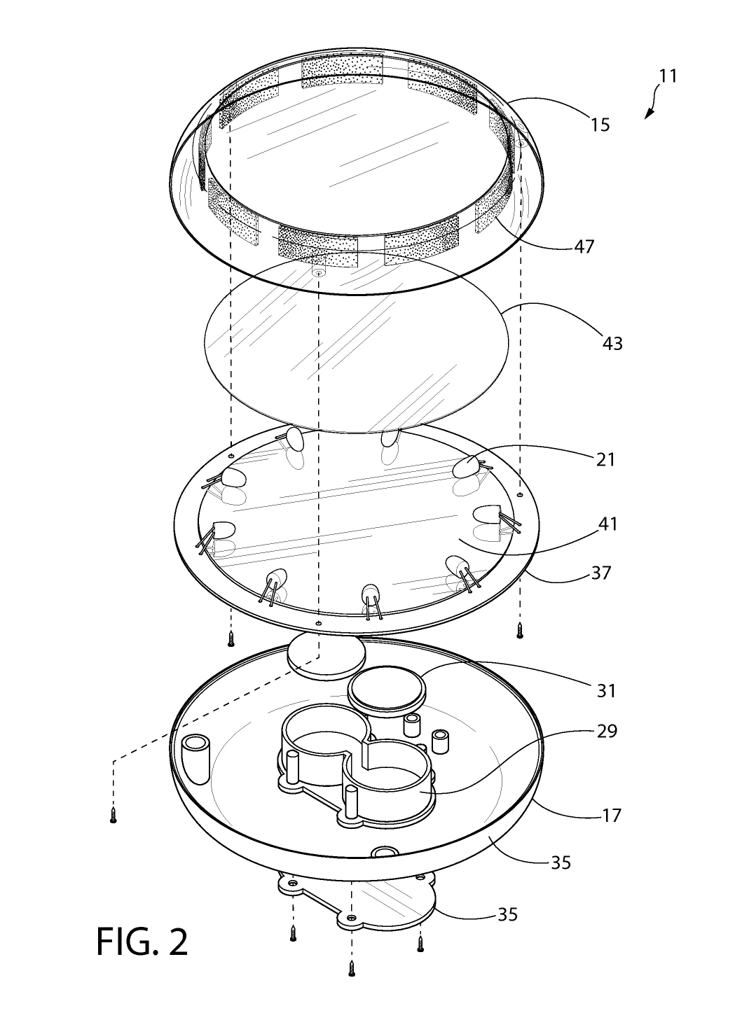

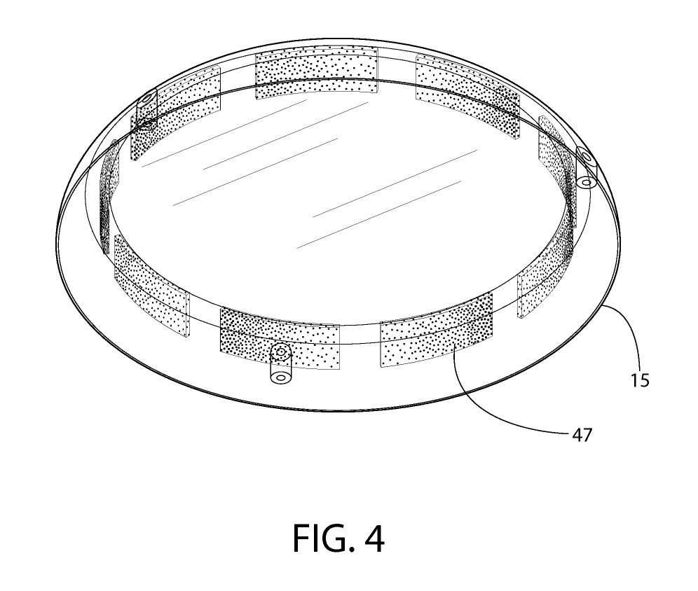

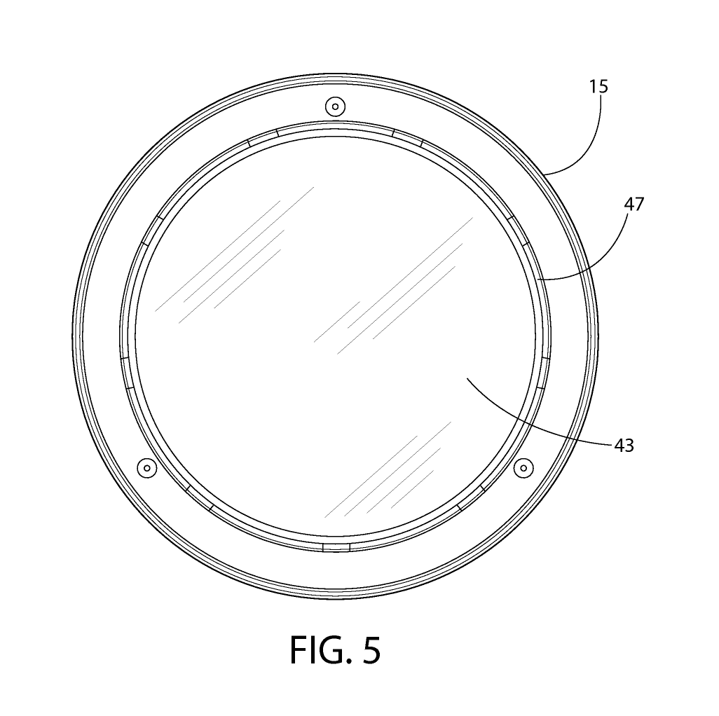

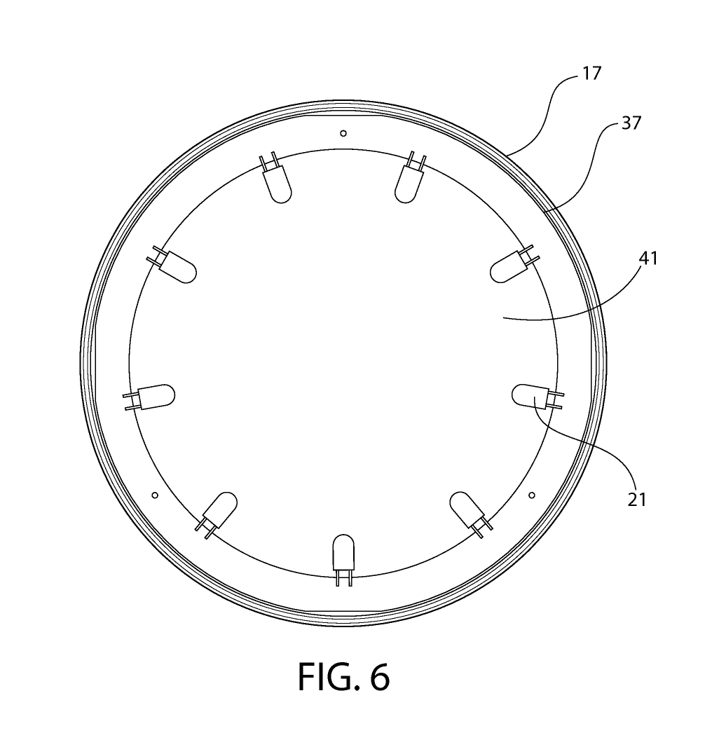

Referring to FIGS. 2-6, the bottom shell 17 of the housing 13 includes a retaining walls 29 to seat the batteries 31, which serve as a power source for the LEDs 21, and a battery cover 33, which is secured to the exterior of the bottom shell 17. The battery cover 33 seals against the bottom shell 17 to protect the interior of the housing 13 against ingress of water. This seal may be substantially water tight, or depending on the use of the light, it may be desirable to construct the seal to be water proof. The bottom shell 17 is round in the embodiment shown and includes upward curving sides 35. In other embodiments, the bottom shell may have other form factors, with the understanding that the form factor of the bottom shell is complementary to the form factor of the top shell, so that the two shells are able to mate and form the periphery seal. In the embodiment shown, the bottom shell 17 is formed of a material that is opaque to light in the visible spectrum. In certain embodiments, the bottom shell 17 forms the outer dimensions of the light 11 so that light from the lighting elements can be fully directed through the top shell 15. Also, in certain embodiments, the bottom shell 17 blocks transmission of at least 95% of light emitted from the lighting elements that may be incident upon it. These features make it so that the decorative illumination provided by the lighting elements is directed either along the surface of the water or away from the surface of the water, instead of down under the water. This is especially desirable for deeper bodies of water, or for bodies of water that are murky.

The internal support plate 37 secures to the bottom shell 17, and the LEDs 21 are secured to the internal support plate 37. The conductive legs of each LED extend through the internal support plate 37 to be connected to the driver circuit (not shown). In some embodiments, the internal support plate 37 may be a printed circuit board (PCB) for the driver circuit, with appropriate driver circuitry secured directly to the PCB. In other embodiments, the driver circuit may be formed on a separate PCB, which is then secured to the underside of the internal support plate. Like the bottom shell 17, the internal support plate 37 may be formed of a material that is opaque to light in the visible spectrum. Alternatively, in other embodiments, the internal support plate 37 may include a coating which is opaque to light in the visible spectrum. Whether the material is opaque or an opaque coating is used, in certain embodiments, the internal support plate 37 blocks transmission of at least 95% of light emitted from the lighting elements that may be incident upon it.

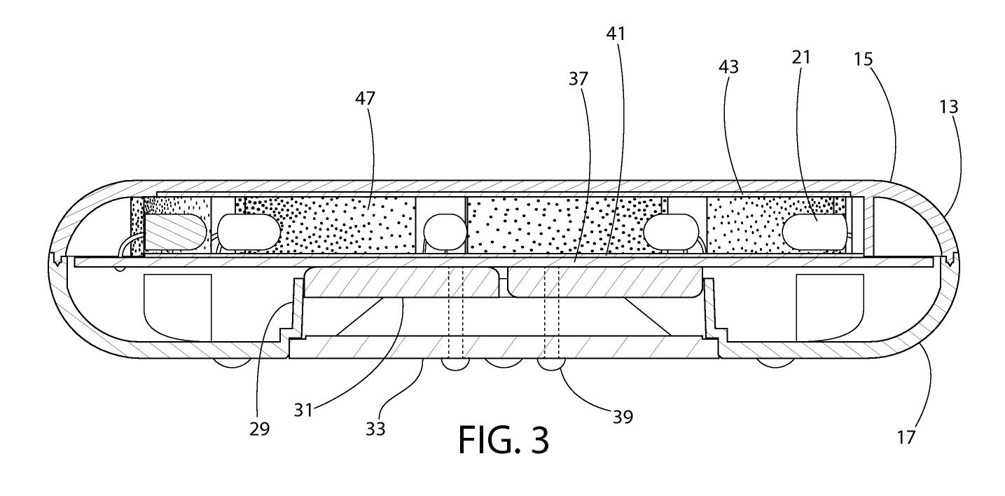

As seen in FIG. 3, the driver circuit may include a power switch that has two electrodes 39 extending to the exterior of the bottom shell 17. These electrodes 39 enable the driver circuit to be powered for illuminating the LEDS when water wets both electrode and completes the circuit between the two electrodes 39. The driver circuit may also include a manually activated power switch, so that a user may select one or more illumination modes for the LEDs. The driver circuit may supply power to the various LEDs using pre-programmed mode, and the types of pre-programmed modes made available to the driver circuit are a matter of design choice. By way of example, the LEDs may all be illuminated in a steady state mode, or they may all be illuminated in a flashing mode. For a flashing mode, the driver circuit may control the rate and order of flashing. By way of other examples, the LEDs may be made to all flash simultaneously, or they may all flash in a selected sequence, or all of one color may turn on, followed by all of another color.

The internal support plate 37 also includes a mirrored surface 41 on the side opposite the bottom shell 17. This mirrored surface 41 is substantially reflective to light in the visible spectrum. In the embodiment shown, this mirrored surface 41 is circular and planar, and it extends under and between all of the LEDs 21. In other embodiments, the mirrored surface may have other form factors and curvatures. For example, it may be convenient from a manufacturing perspective to have the mirrored surface take on a peripheral form factor which matches the distribution of the LEDs, or to have the entire upper surface of the internal support plate be the mirrored surface. In still other embodiments, the mirrored surface may be curved, such as having a concave or convex curvature, depending upon the location and distribution of the LEDs, and upon the desired decorative illumination from the light.

A partial mirror 43 is affixed to the top shell 15 and disposed above the LEDs 21 and opposite the mirrored surface 41. In the embodiment shown, the partial mirror 43 is circular and planar. In other embodiments, the partial mirror may have other form factors and curvatures. For example, it may be convenient from a manufacturing perspective to have the partial minor take on a peripheral form factor which matches the form factor of the mirrored surface. In other embodiments, the partial mirror 43 may be curved, such as having a concave or convex curvature, depending upon the desired decorative illumination from the light.

The extent to which the partial mirror 43 is transparent and reflective will impact the decorative illumination directed through the top shell 15. For example, the partial minor 43 may be 50% reflective and 50% transmissive for light in the visible spectrum. In certain embodiments, the material of the partial minor 43 does not otherwise interact with light, so that light in the visible spectrum is either transmitted through or reflected by the partial mirror 43. In other embodiments, the partial mirror may be between 30%-70% reflective and between 70%-30% transmissive, or between 10%-90% reflective and between 90%-10% transmissive.

The top shell 15 of the housing 13 is forms a transparent outer cover, so that the decorative illumination created by interaction between the LEDs 21, the mirrored surface 41, and the partial mirror 43 is easily seen through the housing 13. The top shell 15 also includes a plurality of light filters 47 which are translucent to light in the visible spectrum. The light filters 47 are affixed to the top shell 15 and extend toward the internal support plate 37, with each light filter 47 being between two of the LEDs 21 along the periphery of the mirrored surface 41. The light filters 47 serve as diffusion filters for light from the LEDs 21 that is directed out the side of the top shell 15, which when the light 11 is floating in water, this diffused light would be directed laterally along the surface of the water. In certain embodiments, just enough spacing is included between adjacent ones of the light filters 47 so that the LEDs can extend through the space to be positioned between the mirrored surface 41 and the partial minor 43. This helps ensure that most of the illumination emerging laterally is diffuse and spread out evenly over the periphery of the light 11, despite being emitted from one or more of the LEDs 21.

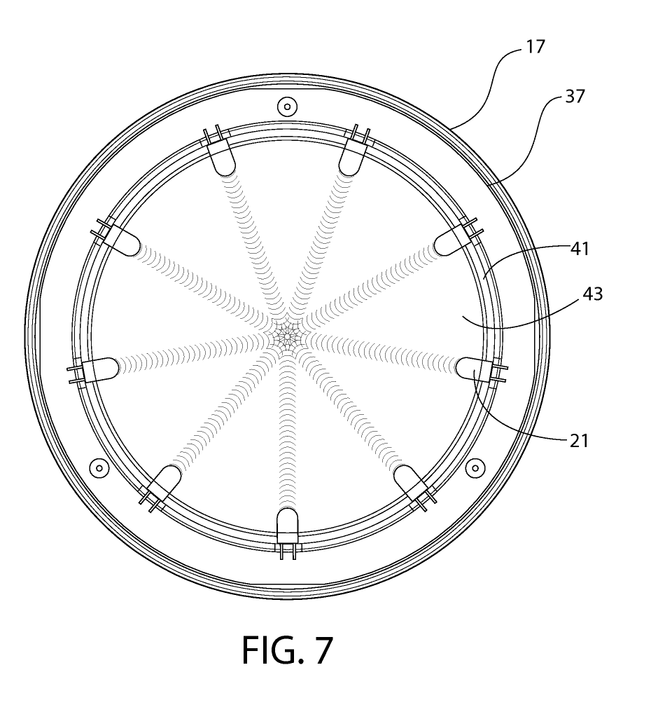

During operation, with LEDs installed that are commonly available on the market, such as hemispheric LEDs having clear encapsulation, much of the light emitted over the 180° emission cone is directed to the light filters positioned across the mirrored surface from each respective LED. The light directed at the various light filters produces diffuse illumination laterally outward from the top shell, which would be along the surface of water when the light is floating. The remaining light emitted from each LED is directed at either the mirrored surface or the partial minor. Most of the light directed at the partial minor is totally reflected toward the partial minor. Depending upon the transmission/reflection properties of the partial mirror, at least part of the light incident on the partial minor is reflected back to the mirrored surface, and reflection back and forth between the partial mirror and the mirrored surface continues. Looking at the top shell of the light from an angle normal to the partial minor, for an embodiment in which the partial mirror is planar, many different reflected images of light emitted from each LED may be seen from the back and forth reflections, as is illustrated in FIG. 7. This creates the illusion of the small light having nearly an infinite amount of space within the housing.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A decorative light comprising:
a housing having a bottom shell and a top shell, the shells configured to seal against each other along an outer perimeter;
a partial mirror affixed to an inside of the top shell;
an internal support plate including a mirrored surface facing the partial mirror;
a plurality of lighting elements disposed between the partial mirror and the mirrored surface;
a plurality of light filters disposed about a periphery of the mirrored surface, with each light filter being disposed between two of the lighting elements.

2. The decorative light of claim 1, wherein the partial minor is partially transmissive and partially reflective to light emitted from the lighting elements.

3. The decorative light of claim 2, wherein the partial minor is at least 50% reflective to light emitted from the lighting elements.

4. The decorative light of claim 1, wherein the partial mirror is planar.

5. The decorative light of claim 1, wherein the mirrored surface is planar.

6. The decorative light of claim 1, wherein each light filter comprises a diffusion filter.

7. The decorative light of claim 1, wherein at least one of the plurality of lighting elements is disposed between adjacent ones of the plurality of light filters.

8. The decorative light of claim 1, wherein the bottom shell is opaque to light emitted from the lighting elements.

9. The decorative light of claim 8, wherein the bottom shell blocks transmission of at least 95% of light emitted from the lighting elements.

10. The decorative light of claim 1, wherein the top shell is transparent to light emitted from the lighting elements.

11. The decorative light of claim 1, wherein the plurality of light filters are translucent to light from the lighting elements.

12. The decorative light of claim 1, further comprising:
a power source electronically coupled to the lighting elements; and
a power switch electronically coupled between the power source and the lighting elements.

13. The decorative light of claim 13, wherein the power switch comprises two electrodes extending to an exterior surface of the bottom shell.

14. The decorative light of claim 1, wherein the bottom shell and the top shell are configured to seal against each other to form a buoyant body.

15. The decorative light of claim 1, wherein each of the lighting elements comprises an LED.
